(19) United States
(12) Patent Application Publication
(10) Pub. No.: US 2025/0337016 A1
(43) Pub. Date: Oct. 30, 2025

(54) COMPOSITIONS AND METHODS FOR FLUOROSURFACTANTS IN METAL ION BATTERIES

(71) Applicant: EKK ADVANCED TECHNOLOGIES, LLC, Armonk, NY (US)

(72) Inventors: Eduard KLEINER, Pound Ridge, NY (US); Martial PABON, New Canaan, CT (US); Colin NUCKOLLS, New York, NY (US); Kevin FITZPATRICK, Ridgefield, CT (US)

(21) Appl. No.: 19/259,726

(22) Filed: Jul. 3, 2025

Related U.S. Application Data
(63) Continuation of application No. PCT/US24/10743, filed on Jan. 8, 2024.
(60) Provisional application No. 63/478,882, filed on Jan. 6, 2023.

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0028

(57) ABSTRACT

The present disclosure provides, inter alia, compositions and methods for improving metal ion battery performance. In some aspects, the present disclosure provides an electrolyte comprising a fluorosurfactant additive that is effective to improve battery lifetime, initial capacity, capacity fade, wetting time, and dendrite formation in a metal ion battery.

### CROSS REFERENCE TO RELATED APPLICATIONS

The present application is a continuation of PCT International Application No. PCT/US2024/010743 filed on Jan. 8, 2024, which claims benefit to U.S. Provisional Patent Application No. 63/478,882, filed Jan. 6, 2023, which applications are incorporated by reference herein in their entireties.

### BACKGROUND

Metal Ion Batteries (MIBs) consist of an anode and a cathode that are kept apart from each other via a semipermeable membrane known as a separator. The battery is completed by filling it with an electrolyte solution containing metal ions. During discharge of the battery, the metal ions move from the anode (negative electrode) through the electrolyte solution to the cathode (positive electrode). When the battery is being charged the lithium ions move in reverse, from the cathode to the anode of the battery.

Lithium Ion Batteries (LIBs) are a ubiquitous type of metal ion batteries. Typically, the anode is lithium intercalated graphite and the cathode is a variety of materials including lithium iron phosphate (LFP), nickel manganese cobalt (NMC) and many others materials with the ability to host lithium ions. Typical liquid electrolytes are comprised of carbonates such as propylene and ethylene carbonate, which dissolve the lithium hexafluorophosphate salt.

While the performance of LIBs is extraordinary there are areas where improvement is needed. There is also a need for improvement for MIBs generally. For example, when the electrolyte is added to the battery, the time it takes to completely wet the complex structures of the electrodes and separator dictates how much time it takes to manufacture batteries. There currently exists a need for faster wetting time to reduce time spent in manufacturing MIBs. Furthermore, it is desirable to have the greatest initial capacity for a battery and for that capacity to stay as high as possible during cycling. Thus, there currently exist a need to improve the initial capacity (and to maintain capacity) of MIBs. Moreover, there are occasionally catastrophic events caused by dendrite formation in some MIBs that cause failure of the battery and, in some cases, cause fires that are extremely challenging to extinguish. Thus, there exists a need to mitigate and/or eliminate these catastrophic events for improved safety and for improved economics (e.g., longer battery lifetime). Finally, the operation of MIBs at low temperature is suboptimal with current technology. Thus, there exists a need to improve performance of MIBs at low temperatures.

To address these and other needs, the present disclosure provides, inter alia, electrolyte additives that can control and modulate the properties of MIBs. In some embodiments, the present disclosure provides additives comprising perfluoroalkyl sulfide terminated oligomers (R_{f}-oligomers), which are effective to improve battery performance.

### SUMMARY OF THE DISCLOSURE

According to some aspects, the present disclosure provides perfluoroalkyl sulfide terminated oligomers and their use in improving the performance of MIBs. In some embodiments, the perfluoroalkyl sulfide terminated oligomers have backbones comprised of oligomeric moieties with varying number of carbons that are made up of hydrophilic (or mixtures of hydrophilic and hydrophobic) monomers. In some embodiments, the perfluoroalkyl sulfide terminated oligomer disclosed herein are added to the metal ion batteries to provide improvement in manifold ways, including, but not limited to, improved wetting time of the electrolyte into the battery, initial capacity of the battery, capacity fade with cycling of the battery, as wells as reduced dendrimer formation and increased battery lifetime. In some embodiments, the perfluoroalkyl sulfide terminated oligomers disclosed herein are those previously used in firefighting foam, and are described in U.S. Pat. Nos. 4,460,480, 4,439,329, 4,089,804, each of which is incorporated by reference herein in its entirety.

According to some aspects, the present disclosure provides an ion battery electrolyte comprising: an electrolyte salt; a solvent; and at least one fluorocarbon surfactant according to Formula I: R_{f}-Eₙ-S-[M₁]ₓ[M₂]_{y}H, wherein R_{f} is a straight or branched chain perfluoroalkyl of 4 to 18 carbon atoms, perfluoroalkyloxyalkylene of 5 to 19 carbon atoms, or mixtures thereof, Eₙ is a straight or branched chain alkylene of 1 to 12 carbon atoms, CON(R′)-E′-, —SO₂N(R′)-E′-, -E″-CON(R′)-E′-, -E″-S-E′-, -E″-N(R′)-E′-; or -E″-SO₂N(R′)-E′-, where R′ is hydrogen or alkyl of 1 to 6 carbon atoms, E′ is alkylene of 2 to 8 carbon atoms and E″ is alkylene of 1 to 4 carbon atoms; [M₁] represents a hydrophilic monomer unit derived from a hydrophilic monomer of the type M₁ as disclosed herein; and [M₂] represents a hydrophobic monomer unit derived from hydrophobic monomers of the type M₂ as disclosed herein; wherein the sum of x and y is between 1 and about 500; x/(x+y) is between 1 and 0.5; in some embodiments, more than one type of -M₁- units and more than one type of -M₂- units are present in the fluorocarbon surfactant; and n is 0 or 1.

In some embodiments, the at least one fluorocarbon surfactant according to Formula I comprises about 0.1% to about 5% by weight of the electrolyte. In some embodiments, M₁ is an acrylamide unit. In some embodiments, the electrolyte salt is an electrolyte lithium salt. In some embodiments, the electrolyte lithium salt is selected from LiClO₄, LiPF₆, LiBF₄, LiCF₃SO₃, LiN(CF₃SO₂)₂, or combinations thereof. In some embodiments, the solvent comprises one or more of dimethyl carbonate, diethyl carbonate, methyl ethyl carbonate. In some embodiments, the electrolyte comprises one or more of compounds according to Example 1, Example 2, Example 3, Example 4, Example 5, Example 6, Example 7, Example 8, Example 9, Example 10, Example 11, Example 12, Example 13, Example 14, Example 15, Example 16, Example 17, Example 18, Example 19, Example 20, Example 21, Example 22, Example 23, Example 24, and Example 25. In some embodiments, the electrolyte comprises one or more of DX1080 and DX1090.

In some embodiments, the at least one fluorocarbon surfactant comprises:

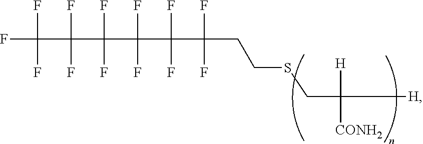

wherein n is an integer from 1 to 30.

In some embodiments, the at least one fluorocarbon surfactant comprises:

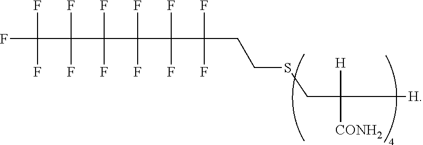

In some embodiments, the at least one fluorocarbon surfactant comprises:

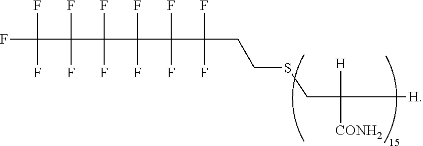

According to some aspects, the present disclosure provides an ion battery comprising: a housing comprising an electric core; and an electrolyte disposed in said housing, wherein the electric core is in contact with the electrolyte; wherein the electrolyte is the ion battery electrolyte as disclosed herein. In some embodiments, the ion battery is a lithium ion battery. In some embodiments, the lithium salt is selected from LiClO₄, LiPF₆, LiBF₄, LiCF₃SO₃, LiN(CF₃SO₂)₂, or combinations thereof. In some embodiments, the electrolyte comprises a solvent selected from dimethyl carbonate, diethyl carbonate, methyl ethyl carbonate, and combinations thereof.

According to some aspects, the present disclosure provides a method for improving performance of a metal ion battery comprising the step of contacting the metal ion battery with the ion battery electrolyte as disclosed herein. In some embodiments, the improved performance includes improved charge capacity, decreased capacity fade during charge, and discharge cycling of the metal ion battery. In some embodiments, the improved performance includes reduced dendrite formation during charge and discharge cycling of the metal ion battery. In some embodiments, the improved performance includes an increased lifetime of the metal ion battery during charge, and discharge cycling under a high cut-off voltage. In some embodiments, the improved performance includes an increased lifetime of the metal ion battery. In some embodiments, the metal ion battery is a lithium ion battery.

According to some aspects, the present disclosure provides a method of decreasing the time required to wet the electrode of a metal ion battery, comprising the step of contacting the electrode with the ion battery electrolyte as disclosed herein. In some embodiments, the metal ion battery is a lithium ion battery. In some embodiments, the electrolyte salt is selected from LiClO₄, LiPF₆, LiBF₄, LiCF₃SO₃, LiN(CF₃SO₂)₂, or combinations thereof. In some embodiments, the solvent comprises one or more of dimethyl carbonate, diethyl carbonate, methyl ethyl carbonate, and combinations thereof.

### BRIEF DESCRIPTION OF THE DRAWINGS

FIG. 1 shows data for internal resistance change of batteries with different surfactants during rest, according to some embodiments disclosed herein. FIG. 1 shows that the electrolyte without additive generally requires a wetting time of more than 4 hours, and with R_{f}-oligomers according to some embodiments disclosed herein, the wetting time is shortened to ˜2 hours.

FIG. 2 shows data for the initial capacity of batteries with different R_{f}-oligomers, according to some embodiments disclosed herein. The R_{f}-oligomers have the same functional groups, but different skeletal lengths (the skeletal length increases from left to right).

FIG. 3 shows data according to certain embodiments disclosed herein for the cycling performance with and without R_{f}-oligomers as disclosed herein.

FIG. 4 shows data according to certain embodiments disclosed herein for the cycling performance with and without R_{f}-oligomers as disclosed herein.

FIG. 5 shows the cycling performance of NMC 532 batteries under a high cut-off voltage of 4.35 V and a rate of 0.5 C according to some embodiments disclosed herein. (A) shows the capacity retention over cycling. (B) shows the Coulombic Efficiency over cycling. The blue dashed circle at ˜70 cycles in (A) and (B) show the initiation of dendrites for the battery without R_{f}-oligomer, followed by the emergence of dendrites in the later cycles. The R_{f}-oligomers used here is from DX1080.

FIG. 6 shows graphite anodes and separators after overcharging 140 cycles according to certain embodiments disclosed herein. (A) show without DX1080 additive in electrolyte and (B) shows with DX1080 additive in the electrolyte. (C) shows the comparison of separators after cycling. Upper image: Surfactant DX1080; Lower image: No surfactant used. (D) and (E). SEM images of graphite anodes after cycling. (D) without DX1080 additives, and (E) with DX1080 additives.

### DETAILED DESCRIPTION

According to some aspects, the present disclosure provides perfluoroalkyl group terminated oligomers derived from perfluoroalkyl mercaptans and hydrophilic and/or hydrophobic monomers that are polymerized through free radical reactions, and their use to improve MIB performance.

According to certain embodiments, the perfluoroalkyl group terminated oligomers (Rf-oligomer) are represented by the following formula I:

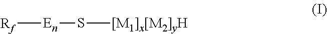

wherein R_{f} is a straight or branched chain perfluoroalkyl of 4 to 18 carbon atoms, perfluoroalkyloxyalkylene of 5 to 19 carbon atoms, or mixtures thereof, Eₙ is a straight or branched chain alkylene of 1 to 12 carbon atoms, —CON(R′)-E′-, —SO₂N(R′)-E′-, -E″-CON(R′)-E′-, -E″-S-E′-, -E″-N(R′)-E′-; or -E″-SO₂N(R′)-E′-, where R′ is hydrogen or alkyl of 1 to 6 carbon atoms, E′ is alkylene of 2 to 8 carbon atoms and E″ is alkylene of 1 to 4 carbon atoms; [M₁] represents a hydrophilic monomer unit derived from a hydrophilic monomer of the type M₁ as defined herein, and [M₂] represents a hydrophobic monomer unit derived from hydrophobic monomers of the type M₂ as defined herein. The sum of x and y is between 1 and about 500; x/(x+y) is between 1 and 0.5; in some embodiments, more than one type of -M₁- units and more than one type of -M₂- units are present in the fluorocarbon surfactant; and n is 0 or 1.

In some embodiments, the formula above does not depict the actual sequence of the oligomer units, since the units can be randomly distributed.

In some embodiments, the oligomers disclosed herein are synthesized by polymerizing a hydrophilic monomer or monomers of the type M₁ with or without a hydrophobic monomer or monomers of the type M₂ in the presence of an R_{f}-mercaptan of formula II

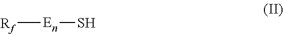

wherein R_{f} and Eₙ are as disclosed herein.

R_{f} mercaptans of formula II are described inter alia in U.S. Pat. Nos. 2,894,991; 2,961,470; 2,965,677; 3,088,849; 3,172,910; 3,554,663; 3,655,732; 3,686,283; 3,883,596; 3,886,201 and 3,935,277; and Australian Application No. 36868; filed Apr. 24, 1968, each of which are incorporated by reference as if recited in full herein.

Suitable R_{f} mercaptans can, alternatively, be easily prepared by reacting an R_{f} acid halide, e.g., R_{f} SO₂ Cl or R_{f} COCl with an amino mercaptan, e.g., H—N(R′)-E′-SH, in an inert solvent.

In some embodiments, hydrophilic monomers of the type M₁ which contain at least one hydrophilic group are known and are commercially available, such as acrylic and methacrylic acid and salts thereof as well as hydrophilic groups containing derivatives such as their hydroxyalkyl esters, e.g., 2-hydroxyethyl, 3-hydroxypropyl, 2-hydroxypropyl or 2,3-hydroxypropyl esters; also ethoxylated and polyethoxylated hydroxyalkyl esters, such as esters of alcohols of the formula

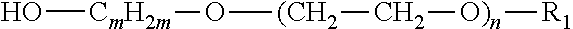

wherein R₁ represents hydrogen or methyl, m represents 2 to 5 and n represents 1 to 20 or esters of analogous alcohols, wherein a part of the ethylene oxide units is replaced by propylene oxide units. Further suitable esters are dialkylaminoalkyl acrylates and methacrylates, such as the 2-(dimethylamino)-ethyl-, 2-(diethylamino)-ethyl- and 3-(dimethylamino)-2-hydroxypropyl esters. Another class of hydrophilic monomers are acrylamide and methacrylamide as well as amides substituted by lower hydroxyalkyl, lower oxaalkyl- or lower dialkylaminoalkyl groups such as N-(hydroxymethyl)-acrylamide and -methacrylamide, N-(3-hydroxypropyl)-acrylamide, N-(2-hydroxyethyl)-methacrylamide, N-(1,1-dimethyl-3-oxabutyl)-acrylamide and N-[1,1-dimethyl-2-(hydroxymethyl)-3-oxabutyl)]-acrylamide; further hydrophilic monomers of interest are hydrazine derivatives, such as trialkylamine methacrylimide, e.g., trimethylamine-methacrylimide and dimethyl-(2-hydroxypropyl)amine methacrylimide and the corresponding derivatives of acrylic acid; mono-olefinic sulfonic acids and their salts, such as sodium ethylene sulfonate, sodium styrene sulfonate and 2-acrylamido-2-methylpropanesulfonic acid; N-[2-(dimethylamino)-ethyl]-acrylamide and -methacrylamide, N-[3-(dimethylamino)-2-hydroxypropyl]-methacrylamide, or mono-olefinic derivatives of heterocyclic nitrogen-containing monomers, such as N-vinyl-pyrrole, N-vinyl-succinimide, 1-vinyl-2-pyrrolidone, 1-vinyl-imidazole, 1-vinyl-indole, 2-vinyl-imidazole, 4(5)-vinyl-imidazole, 2-vinyl-1-methyl-imidazole, 5-vinyl-pyrazoline, 3-methyl-5-isopropenyl, 5-methylene-hydantoin, 3-vinyl-2-oxazolidone, 3-methacrylyl-2-oxazolidone, 3-methacrylyl-5-me-2-oxazolidone, 3-vinyl-5-methyl-2-oxazolidone, 2- and 4-vinyl-pyridine, 5-vinyl-2-methyl-pyridine, 2-vinyl-pyridine-1-oxide, 3-isopropenyl-pyridine, 2- and 4-vinyl-piperidine, 2- and 4-vinyl-quinoline, 2, 4-dimethyl-6-vinyl-s-triazine, 4-acrylyl-morpholine as well as the quaternized derivatives of the above pyridines.

In some embodiments, the above listed hydrophilic monomers of type M₁ can be used alone or in combination with each other as well as in combination with suitable hydrophobic monomers of type M₂.

In some embodiments, hydrophilic monomers of type M₁ which require a comonomer for polymerization are maleates, fumarates and vinylethers; the following monomer combinations are, for instance, useful: di(hydroxyalkyl) maleates, such as di(2-hydroxyethyl) maleate, and ethoxylated hydroxyalkyl maleates, hydroxyalkyl monomaleates, such as 2-hydroxyethyl monomaleate and hydroxylated hydroxyalkyl monomaleate with vinyl ethers, vinyl esters, styrene or generally any monomer which will easily copolymerize with maleates or fumarates; hydroxyalkyl vinyl ethers, such as 2-hydroxyethyl vinyl ether, 4-hydroxybutyl vinyl ether, with maleates, fumarates, or generally all monomers which will easily copolymerize with vinyl ethers.

In some embodiments, the hydrophilic monomers of type M₁ are acrylic acid, methacrylic acid, acrylamide, diacetone acrylamide, acrylamidopropane sulfonic acid and salts thereof, and hydroxyethyl methacrylate.

In some embodiments, hydrophobic monomers of the type M₂ which do copolymerize with hydrophilic monomers of type M₁ are known and include: acrylates, methacrylates, maleates, fumarates and itaconates with one or more carbons in the ester group, such as methyl, ethyl, propyl, isopropyl, butyl, hexyl, octyl, decyl, dodecyl, 2-ethylhexyl, octadecyl, cyclohexyl, phenyl, benzyl and 2-ethoxyethyl;

Vinyl esters with 1 to 18 carbons in the ester group, such as vinyl acetate, butyrate, laurate, stearate, 2-ethyl-hexanoate and benzoate; vinyl chloracetate and isopropenyl acetate, vinyl carbonate derivatives;

Styrene and substituted styrenes such as o- and p-methyl, 3,4-dimethyl, 3,4-diethyl and p-chlorostyrene; alpha olefins which include substituted alpha olefins both straight and branched with up to 18 carbon atoms in the side chain including ethylene, propylene and butylene;

Methyl vinyl ether, isopropyl vinyl ether, isobutyl vinyl ether, 2-methoxyethyl vinyl ether, n-propyl vinyl ether, t-butyl vinyl ether, isoamyl vinyl ether, n-hexyl vinyl ether, 2-ethylbutyl vinyl ether, diisopropylmethyl vinyl ether, 1-methylheptyl vinyl ether, n-decyl vinyl ether, n-tetradecyl vinyl ether, and n-octadecyl vinyl;

Vinyl chloride, vinylidene chloride, vinyl fluoride, vinyldene fluoride, acrylonitrile, methacrylonitrile, tetrafluoroethylene, trifluorochloroethylene, hexafluoropropylene;

Dienes particularly 1,3-butadiene, isoprene, and chloroprene, 2-fluoro-butadiene, 1,1,3-trifluorobutadiene, 1,1,2,3-tetrafluorobutadiene, 1,1,2-trifluoro-3,4-dichlorobutadiene and tri- and pentafluorobutadiene and isoprene.

In some embodiments, the hydrophobic monomer of the type M₂ is a fluorinated monomer.

In some embodiments, the mercaptans act as so-called chain transfer agents in free-radical polymerization and copolymerization reaction. The previously listed hydrophilic monomers of type M₁ and hydrophobic monomers of type M₂ will either homopolymerize and/or copolymerize in the presence of a free-radical initiator and therefore readily react with R_{f}-mercaptans of formula II forming the instant R_{f}-oligomers of formula I in high yield.

In some embodiments, the polymerization reaction is performed in an essentially water free reaction medium, preferably in a lower alcohol such as methanol or isopropanol, or acetone or a lower cellosolve which dissolve the reactants and catalyst.

In some embodiments, the oligomerization temperature is maintained at a temperature between 20 degree and 60 degrees C., but temperatures up to 100 degrees C. may be used. Optimum temperature may be readily determined for each oligomerization and will depend on the reaction, the relative reactivity of the monomers and the specific feed-radical initiator used. In some embodiments, in order to facilitate the free-radical propagation necessary for an effective catalyst reaction an oxygen-free atmosphere is desirable, and the oligomerizations are carried out under nitrogen.

In some embodiments, the catalyst employed must be a free-radical initiator, such as the peroxides, persulfates or azo compounds. In some embodiments, organic peroxides and hydroperoxides, hydrogen peroxides, azo catalysts and water soluble persulfates are used. Specific examples include ammonium persulfate, lauroyl peroxide, tertbutyl peroxide and particularly the azo catalysts 2,2′-azobis(isobutyronitrile); 2,2′-azobis(2,4-dimethylvaleronitrile); 2-tert-butylazo-2-cyanopropane; 1-tert-butylazo-1-cyanocyclohexane; and 2,2′-azobis(2,4-dimethyl-4-methoxyvaleronitrile).

In some embodiments, catalytic amounts of initiator are used, that is between 0.01 and 0.5% by weight of monomers depending on the particular initiator and monomer system. In some embodiments, azo catalyst from 0.01 to 0.2% by weight of azocatalyst per weight of monomers are used.

In some embodiments, the R_{f}-oligomers from monomers of type M₁ and M₂ are synthesized in a one step polymerization reaction described above. However, it is also possible to synthesize the R_{f}-oligomers in a two step synthesis. In this alternate synthesis method, hydrolyzable hydrophobic monomers of type M₂ are polymerized in the presence of an R_{f}-mercaptan of formula II yielding an R_{f}-oligomer containing -M₂- monomer units. In a second step, such R_{f}-oligomers are hydrolyzed with a base, preferably alcoholic sodium or potassium hydroxide solution. In this hydrolysis process, selected -M₂- monomer units are converted into hydrophilic -M₁- monomer units. In this way, vinyl acetate monomer units are converted into vinyl alcohol monomer units or maleate ester units are converted into maleic acid salt units. Similarly, an R_{f}-oligomer containing maleic anhydride monomer units can be hydrolyzed or amidized.

In some embodiments, R_{f}-oligomers of formula I

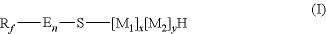

are synthesized to balance the oleophobic and hydrophobic properties of the R_{f}-E-S-segment versus the hydrophilic properties of the -M₁- monomer units and the hydrophobic properties of the -M₂- monomer units in the oligomer. In some embodiments, to achieve a desired balance of properties more than one type of -M₁- units and more than one type of -M₂- units are present in the oligomer. In some embodiments, the incorporation of hydrophobic -M₂- monomer units is not necessary to achieve the proper balance of oleophobic/hydrophobic versus hydrophilic properties.

Further, in some embodiments the chain length of the R_{f}-group and the nature and ratio of the M₁ and M₂ monomer units is varied to achieve a desired property. In some embodiments, the R_{f}-oligomers achieve a solubility in water or water-solvent mixtures of at least 0.01% by weight of R_{f}-oligomer.

In some embodiments, M₁ and M₂ type monomers are selected by varying the degree of polymerization, i.e. the weight ratio of the R_{f}-E-S segment versus the segment formed by -[M₁]ₓ[M₂]_{y}H, R_{f}-oligomers, which reduce the surface tension of aqueous systems to any desirable degree and as low as 16 dynes/cm. In some embodiments, it is possible to tailor R_{f}-oligomer compositions which provide any desirable surface tension in water between 76 dynes/cm and about 16 dynes/cm. In some embodiments, the R_{f}-oligomers can therefore be used in applications where improved wetting and spreading of liquids on difficult to wet substrates or substrates contaminated with oil or silicones is required.

In some embodiments, R_{f}-oligomers of formula I

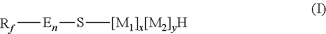

are prepared from a wide variety of R_{f}-mercaptans of formula II

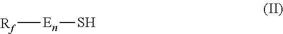

and a vast number of commercially available monomers of type M₁ and M₂ as defined herein.

In some embodiments, R_{f} is a perfluoroalkyl group with 6 to 14 carbon atoms,
E is alkylene, preferably ethylene,

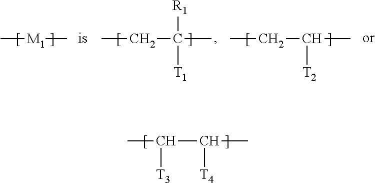

wherein T₁ is —COOMe; —CONH₂; —CONHR₂; —CONH₂ R₃; —CONH-E₁ -NR₂ R₃; —CONH-E₁ -NR₂ R₃ R₄ X; —CONHCH₂ OH; —CONHCH₂ OR₂; —CONHE₂ OH; —CO(OE₁)ₙ OR₁; —COOCH₂ CHOHCH₂ OH; —CONH-E₂-SO₃ Me; —CON(E₁ OH)₂;
T₂ is —OH; —OE₂ OR₁; —(OE₁)_{n OR1}; —SO₃ Me; —C₆ H₄ SO₃ Me;

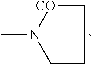

pyridinium halide, —NHCOR₁, —NH₂ T₃& T₄ are independently —COOMe; —CONH₂; —CO(OE₁)ₘ OR₁; —CONH-E₁ -OH; —CON(E₁ -OH)₂
R₁ is hydrogen or methyl
R₂, R₃, R₄ are independently alkyl with 1 to 6 carbons
E₁ is alkylene with 2 or 3 carbons
E₂ is alkylene with 2 to 6 carbons
Me is hydrogen or alkali metal
X is halide and
n is 1 to 20

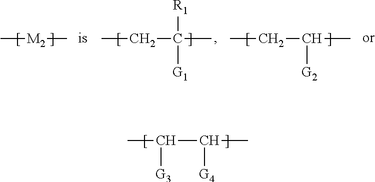

wherein G₁ is —COOR₅; —OCOR₂; —CN; —OR₅; —C₆ H₅; —C₆ H₄ X
G₂ is —H, R₂ or halide
G₃ and G₄ are independently —COOR₅ or combined can be —CO—O—CO—
R₁, R₂, X are as previously defined
R₅ is alkyl with 1 to 18 carbons or cycloalkyl, aryl, alkenyl with 6 to 18 carbons
The sum of x and y is between 4 and about 500; and x/(x+y) is between 0.5 and 1.

In some embodiments, the sum of x and y is between 10 and about 200, most preferably between 10 and about 100 and x/(x+y) is about 0.5 to 1.

In some embodiments, R_{f}-oligomers have the structure R_{f}-E-S-[M₁]ₓ H, wherein R_{f} is linear perfluoroalkyl with 6 to 12 carbon atoms
E is —CH₂ CH₂—

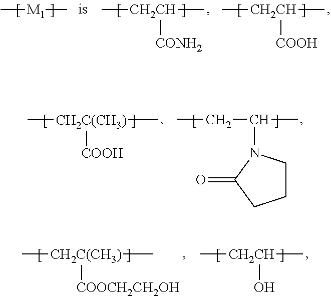

and x is 4 to 50.

In some embodiments, R_{f}-oligomers used as electrolyte additives have the above listed structure R_{f}-E-S-[M₁]ₓ H wherein -M₁- is

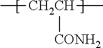

and x varies from 10 to 50.

According to some embodiments, electrolyte additives comprise one or more of the compounds according to Example 1, Example 2, Example 3, Example 4, Example 5, Example 6, Example 7, Example 8, Example 9, Example 10, Example 11, Example 12, Example 13, Example 14, Example 15, Example 16, Example 17, Example 18, Example 19, Example 20, Example 21, Example 22, Example 23, Example 24, or Example 25. According to some embodiments, electrolyte additives comprise one or more commercial products, such as DX1080 or DX1090 (Dynax). In some embodiments, the commercial products, such as DX1080 or DX1090, are added dry to the electrolyte. Drying consists in heating the product in a vacuum oven until constant weight is achieved.

In some embodiments, the electrolyte additives disclosed herein are represented by a structure with a repeating unit with an integer representing the number of repeating units. See Examples. A person of ordinary skill in the art would understand that the integer is an average value determined by the stoichiometry between the mercaptan and the polymerizable monomers. The resulting oligomer is not constituted of one defined molecular weight but rather a molecular weight distribution centered around an average value.

In some embodiments, the electrolyte additive comprises:

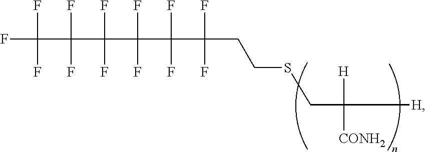

wherein n is an integer between 1 and 40;

In some embodiments the electrolyte additive comprises one or more of:

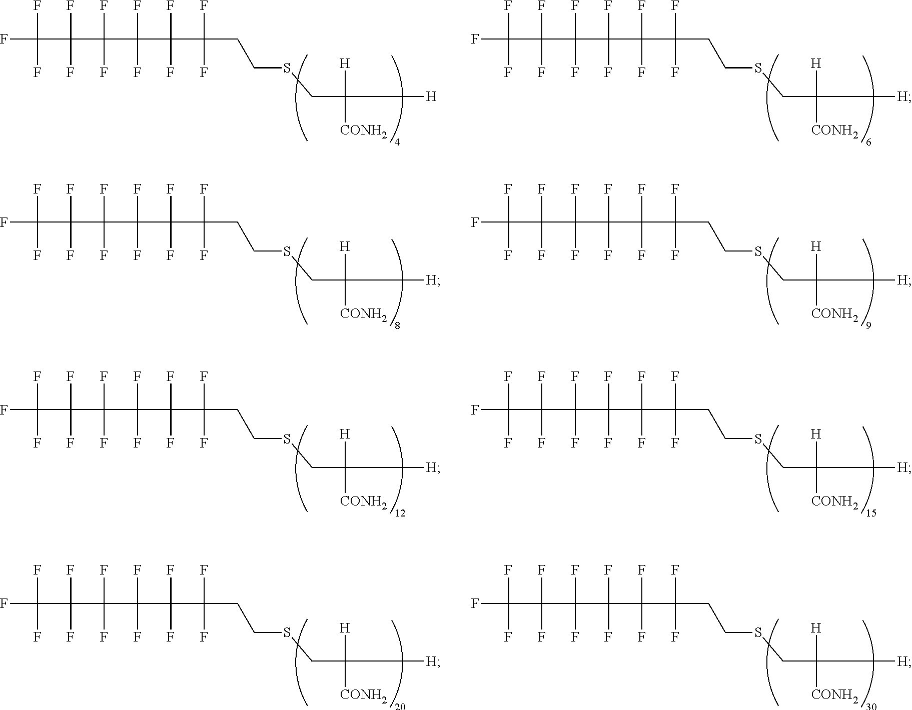

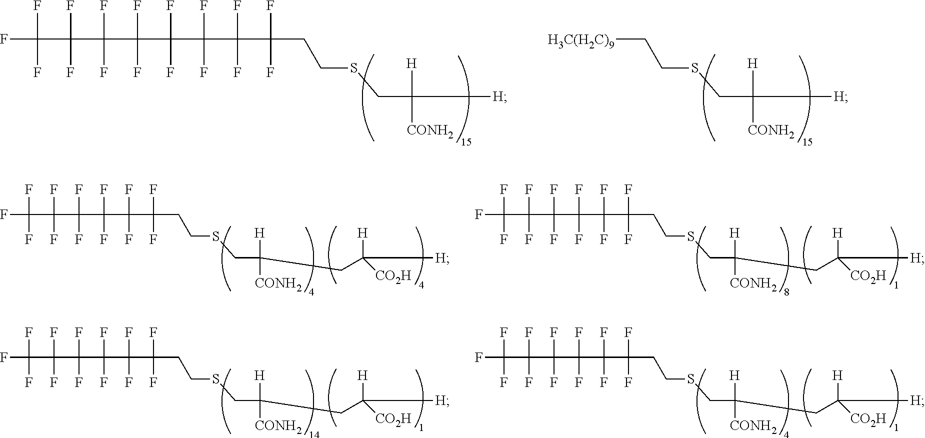

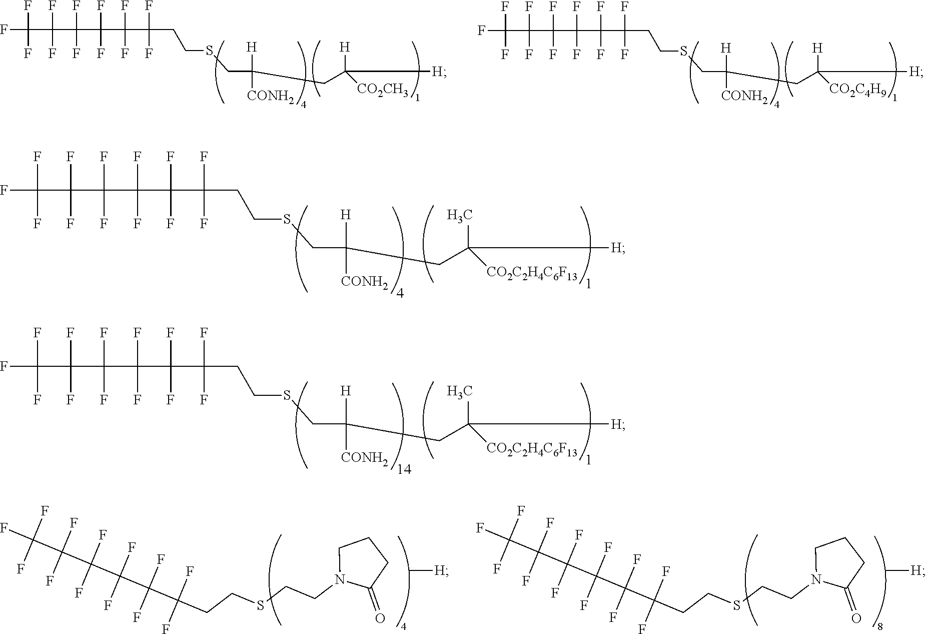

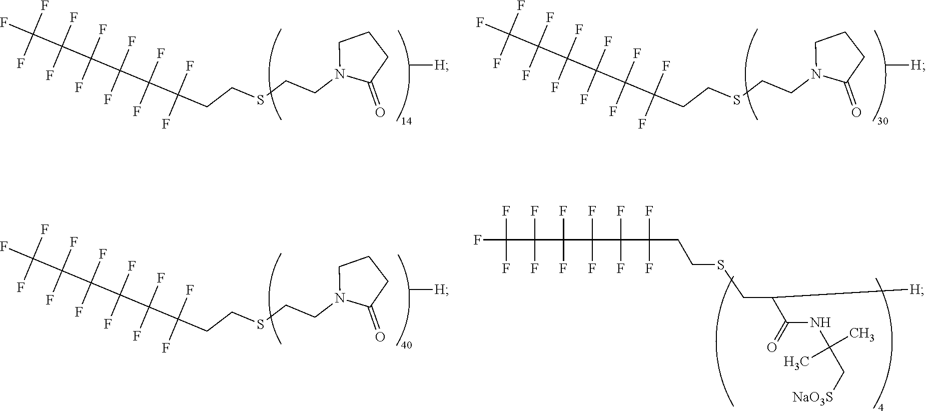

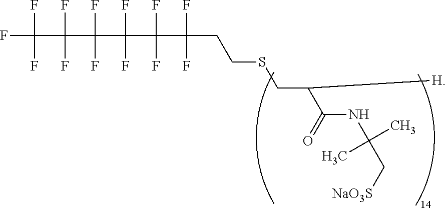

### Use of R_{f}-oligomers Disclosed Herein in Electrolyte of MIBs

According to some aspects, the R_{f}-oligomers disclosed herein are useful as additives to an electrolyte for a MIB, such as a lithium-ion battery. In some embodiments, the R_{f}-oligomers are present in the electrolyte in the amount of about 0.01%, 0.03%, 0.05%, 0.08%, 0.1%, 0.2%, 0.3%, 0.4%, 0.1%, 0.5%, 0.6%, 0.7%, 0.8% 0.9%, 1%, 1.5%, 2%, 2.5%, 3%, 3.5% 4%, 4.5%, or 5% by weight of the electrolyte. In some embodiments, R_{f}-oligomers are present in the electrolyte in the amount of about 0.001% to 5% by weight of the electrolyte. In some embodiments, R_{f}-oligomers are present in the electrolyte in the amount of about 0.01% to 2% by weight of the electrolyte. In some embodiments, R_{f}-oligomers are present in the electrolyte in the amount of about 0.05% to 1% by weight of the electrolyte.

In some embodiments, the classes of R_{f}-oligomers disclosed herein added to the electrolyte are selected from the group consisting of: polyethylene oxide, Amphoteric/Zwiterionic, anionic, cationic, non-ionic, Acrylamide oligomers, Acrylamide co-oligomers, N-Vinyl Pyrrolidone oligomers, Phosphate, Sulfonate, and combinations thereof. In some embodiments, the R_{f}-oligomers disclosed herein added to the electrolyte comprise PEG containing units, PPG containing units, polyacrylic acid containing units, polyacrylamide containing units, and PVA containing units. In some such embodiments, the R_{f}-oligomers disclosed herein added to the electrolyte comprise at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, or at least 30 units per molecule.

In some embodiments, the R_{f}-oligomers disclosed herein added to the electrolyte comprise acrylamide units. In some embodiments, the R_{f}-oligomers disclosed herein added to the electrolyte comprise at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, or at least 30 acrylamide units per molecule.

### Electrolyte Salts

In some embodiments, the electrolytes disclosed herein comprise a salt that is easily dissolved or dissociated in a solvent. In some embodiments, the electrolyte comprises a lithium salt. In some embodiments, the lithium salt is selected from LiClO₄, LiPF₆, LiBF₄, LiCF₃SO₃, LiN(CF₃SO₂)₂, or combinations thereof. In some embodiments, the electrolyte comprises a magnesium salt. In some embodiments, the magnesium salt is selected from Mg(TFSI)₂; MgSO₄; MgX₂, where X=halogen; Mg(trifoliate)₂; Mg(RCO₂—)₂ where R can be methyl, alkyl, halogenated methyl and ethyl; Mg(B(C₂O₄)₂)₂; Mg(BOB)₂; magnesium titanate@superoxomagnesium titanate; magnesium titanate (MgTiO₃); Magnesium dititanate (MgTi₂O₅), [Mg(L)ₓ][Al(ORF)₄]₂ x=3, 6 L=(L=MeCN (acetonitrile), DME (1,2-dimethoxyethane), (ORF═OCCF₃); Mg[B(hfip)₄]₂, Mg[B(tftb)₄]₂, where hexafluoro-tert-isopropoxy is (hfip) and trifluoro-tert-butoxy is (tftb); and the like or combinations thereof. In some embodiments, the electrolyte comprises an aluminum salt. In some embodiments, the aluminum salt is as recited herein for magnesium salts, but the magnesium is substituted with aluminum trivalent. In some embodiments, the aluminum salts are selected from the group consisting of Al(L)₃, L=halogen; (Al(TFSI)₃); (Al(ClO₄)₃); (Al(OTF)₃); Al—Zn/Al(OTF)₃; or combinations thereof.

### Electrolyte Solvents

In some embodiments, the electrolyte comprises an organic solvent that has a high solubility for one or more salts and low viscosity to aid in movement of ions. In some embodiments, the electrolyte comprises an organic solvent that has a high solubility for lithium salt and low viscosity to aid in movement of lithium ions. Such solvents include, for example, cyclic carbonate solvents, chain carbonate solvents, and combinations thereof. In some embodiments, the solvent comprises one or more of dimethyl carbonate, diethyl carbonate, methyl ethyl carbonate, and combinations thereof. In some embodiments, the solvent comprises ethylene carbonate, propylene carbonate, and combinations thereof. In some embodiments, the solvent comprises pyrocarbonates such as dialkyl pyrocarbonates used directly or added to a dialkyl carbonate mix to better control CO₂ evolution. In some embodiments, the solvent comprises ethereal solvents. In some embodiments, the solvent comprises one or more of Tert-Amyl ethyl ether; Cyclopentyl methyl ether; Di-tert-butyl ether; Di(propylene glycol) methyl ether; Dibutyl ether; Diethyl ether; Diisopropyl ether; Dimethoxyethane; Dimethoxymethane; 1,4-Dioxane; Ethyl tert-butyl ether; Methoxyethane; 2-(2-Methoxyethoxy)ethanol; Methyl tert-butyl ether; 2-Methyltetrahydrofuran; Morpholine; Polyethylene glycol; Propylene glycol methyl ether; Tetrahydrofuran; Tetrahydrofurfuryl alcohol; Tetrahydropyran; 2,2,5,5-Tetramethyltetrahydrofuran, and combinations thereof. In some embodiments, the electrolyte is LP50 electrolyte: 1 M LiPF₆ in ethylene carbonate (EC)-ethyl methyl carbonate (EMC) (v/v=1:1).

### Other Additives

In some embodiments, the electrolytes comprise additives in addition to the R_{f}-oligomers disclosed herein disclosed herein. In some embodiments, the additive is a substance that protects the cathode and/or anode. In some embodiments, cathode additives are included to stabilize the cathode structure and protect the surface to slow battery aging. In some embodiments, anode additives are included to stabilize the anode structure and protect the surface to slow battery aging. In some embodiments, the electrolyte comprises surfactants, SEI forming additives, materials to adjust viscosity, materials to help solubilize salts, and combinations thereof. In some embodiments, the electrolyte comprises cathode protection agents, such as Butylamine, N,N′-dicyclohexylcarbodimide (DCI), Lithium bis(oxalate)boronate (LiBOB), and combinations thereof. In some embodiments, the electrolyte comprises LIPF₆ salt stabilizer additives, such as Tris(2,2,2-trifluroethylphosphite (TTFP), 1-methyl2-pyrrolidinone, hexamethyl-phosphoramide, and combinations thereof. In some embodiments, the electrolyte comprises overcharge protector additives, such as Bipyridyl carbonate, Diphenyl carbonate, difluororanisole, thianthrene, 2,7-diacetyl thianthrene, and combinations thereof. In some embodiments, the electrolyte comprises a fire retardant additive, such as Trimethyl phosphate. In some embodiments, the electrolyte comprises a lithium deposition improver, such as Cetyltrimethylammonium chloride. In some embodiments, the electrolyte comprises an ionic salvation enhancer, such as tris(pentafluorophenyl)borane (TPFPB). In some embodiments, the electrolyte comprises an Al corrosion inhibitor, such as Lithium bis(oxalate)boronate (LiBOB).

### Batteries

According to some aspects, the present disclosure provides ion batteries comprising a housing and an electric core. The electric core comprises the anode, cathode, and separator, each of which is in contact with an electrolyte. In some embodiments, the negative electrode (anode) is made from a graphite carbon and the positive electrode (cathode) is made from a layered oxide (e.g., lithium cobalt oxide), a polyanion (e.g., lithium iron phosphate) or a spinel (e.g., lithium manganese oxide). In some embodiments disclosed herein, the cathode electrodes are either polycrystalline LiNi_{0.5}Mn_{0.3}Co_{0.2}O₂ (NMC 532) or single crystalline LiNi_{0.5}Mn_{0.3}Co_{0.2}O₂(NMC 721). In some embodiments, the anode electrodes comprise one or more of graphite, lithium, magnesium, and aluminum. In some embodiments, the electrodes are baked in a vacuum under 80° C. for 48 hours to remove moisture. In some embodiments, the housing is a rigid or semi-rigid structure that is effective to prevent the atmosphere and/or moisture from contacting the electric core/electrolyte.

### Effects of R_{f}-oligomers Disclosed Herein on Battery Performance

According to some embodiments, the R_{f}-oligomers disclosed herein are added to an electrolyte to improve one or more of the following issues relating to battery performance: dendrite formation, battery lifetime, initial capacity, capacity fade, and wetting time. In some embodiments, the R_{f}-oligomers disclosed herein disclosed herein may also have a positive effect on a battery's performance when above or below room temperature.

### Wetting Time:

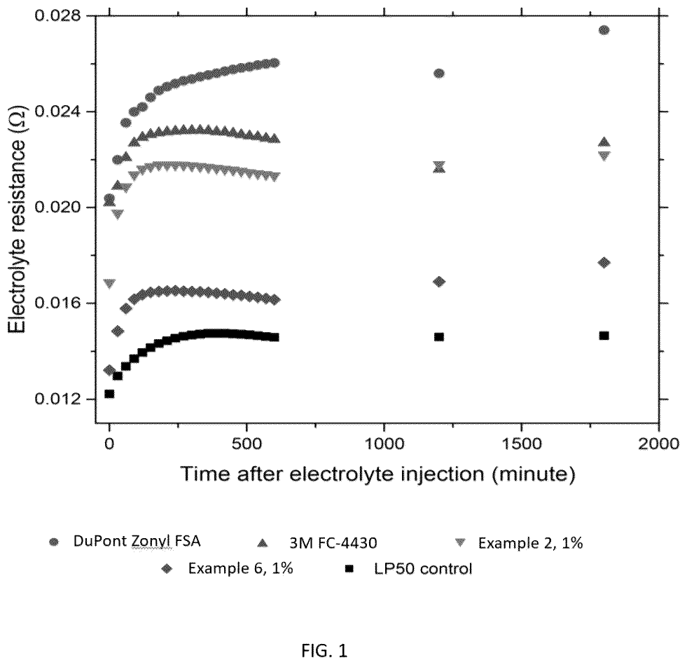

According to some embodiments, the R_{f}-oligomers disclose herein are effective to reduce the wetting time of electrolyte when contacted with battery components. In some embodiments, the wetting time of the electrolyte comprising R_{f}-oligomers disclosed herein is reduced by about 1% to about 80% when compared to wetting time of the same electrolyte without R_{f}-oligomers. In some embodiments, the wetting time is reduced by at least 10%, at least 20%, at least 30%, at least 40%, or at least 50%. Wetting time is defined as the time of electrolyte resistance to reach plateau after electrolyte injection. See, e.g., FIG. 1.

### Initial Capacity:

In some embodiments, the R_{f}-oligomers disclosed herein are effective to increase initial capacity of a battery when added to the electrolyte. The initial capacity is defined as the capacity of the first cycle. In some embodiments, the R_{f}-oligomers disclosed herein are effective to increase the initial capacity of a MIB by about 1% to about 50%. In some embodiments, the R_{f}-oligomers disclosed herein are effective to increase the initial capacity of a MIB by at least 1%, at least 5%, at least 10%, at least 15%, at least 20%, at least 25%, or at least 30%.

In some embodiments, the R_{f}-oligomers disclosed herein are effective to increase the initial capacity of MIBs comprising high porosity and/or low porosity electrodes. In some embodiments, the R_{f}-oligomers disclosed herein are effective to increase the initial capacity of MIBs comprising single crystal and polycrystalline electrodes. In some embodiments, the R_{f}-oligomers disclosed herein are effective to increase the initial capacity of a battery comprising a polycrystalline LiNi_{0.5}Mn_{0.3}Co_{0.2}O₂ electrode. In some embodiments, the R_{f}-oligomers disclosed herein are effective to increase the initial capacity from 4.75 Ah to about 5.25 Ah for a battery comprising a polycrystalline LiNi_{0.5}Mn_{0.3}Co0.2O₂ electrode. In some embodiments, the R_{f}-oligomers disclosed herein are effective to increase the initial capacity from 4.2 Ah to 5.0 Ah for a battery comprising single-crystalline LiNi_{0.5}Mn_{0.3}Co_{0.2}O₂ electrode.

### Cycling Stability/Battery Lifetime:

In some embodiments, the R_{f}-oligomers disclosed herein are effective to improve cycling stability and battery life when included in the electrolyte. As used herein, the term “cycling” means the process where a battery is charged and discharged to determine how well it holds its charge capacity over many cycles. In some embodiments, the cycling stability is evaluated using a charging/discharging rate of 0.5 C. In some embodiments, the R_{f}-oligomers disclosed herein are effective to maintain at least 90% of initial capacity after at least 100 cycles, at least 200 cycles, at least 300 cycles, at least 400 cycles, or at least 500 cycles. In some embodiments, the R_{f}-oligomers disclosed herein are effective to maintain at least 95% of initial capacity after at least 100 cycles, at least 200 cycles, at least 300 cycles, at least 400 cycles, or at least 500 cycles.

### Dendrite Suppression:

In some embodiments, the R_{f}-oligomers disclosed herein are effective to decrease dendrite formation when added to an electrolyte. In some embodiments, the R_{f}-oligomers disclosed herein are effective to decrease dendrite formation when added to an electrolyte when the battery is operated under overcharging conditions. In some embodiments, the R_{f}-oligomers disclosed herein are effective to decrease dendrite formation.

### EXAMPLES

### Battery Testing

Battery testing was performed using the following procedures to test for improvements in the identified target performance areas:

### Electrodes and Electrolytes Used:

The cathode electrodes used in this experiment were either polycrystalline LiNi_{0.5}Mn_{0.3}Co_{0.2}O₂(NMC 532) or single crystalline LiNi_{0.5}Mn_{0.3}Co_{0.2}O₂(NMC 721). Two kinds of cathodes were tested here. The anode electrodes used in this experiment were graphite for all batteries. Before the assembly of batteries, all electrodes are baked in a vacuum under 80° C. for 48 hours to remove moisture.

The electrolyte solutions comprising fluorosurfactants as disclosed herein were mixed in a glove box and then then added to a blank battery. The battery was then sealed and taken out of the glovebox to be cycled under constant pressure.

The final batteries typically had capacities around 5 Ah. The electrolyte used was standard LP50 electrolyte: 1 M LiPF₆ in ethylene carbonate (EC)-ethyl methyl carbonate (EMC) (v/v=1:1), and the amount used for each battery was around 20 mL. The surfactants used in this test were 0.5 wt % in active of electrolyte unless otherwise indicated. All surfactants could be dissolved after being stirred at 50° C. for 48 hours. All batteries were sealed in pouches using the vacuum sealer with a pressure of −970 mBar and a temperature of 180° C.

### Wetting Time:

All batteries had the same wetting procedures. After assembly, the batteries would rest at room temperature for 10 hours to monitor the fluctuation of voltage and internal resistance. A steady voltage and stable internal resistance indicate that the wetting has reached a stable or meta-stable state. The batteries were then treated further with elevated temperature (40° C.) for 48 hours to achieve better wetting, and aged with current of 0.05 C for 4 hours, followed by a current of 0.1 C for 4 hours. After aging, the pouch cells were cut open to release the gas formed during aging and ˜3 mL of electrolyte was added to replenish the electrolyte consumption during aging. Finally, the cells were re-sealed and rested at room temperature for 6 hours before cycling tests.

### Initial Capacity:

After the resting and aging protocols, all batteries were cycled at a rate of 0.5 C. The initial capacity is defined as the capacity of the first cycle. These data reflect the wetting conditions of electrodes since better wetting results in the reactions of more electrode materials, hence more capacity. As discussed below, the results show that the surfactant as disclosed herein can significantly improve the wetting condition. For polycrystalline LiNi_{0.5}Mn_{0.3}Co_{0.2}O₂ electrode, the initial capacity can be improved from 4.75 Ah to ˜5.25 Ah; for single-crystalline LiNi_{0.5}Mn_{0.3}Co_{0.2}O₂, the wetting is more difficult than the polycrystalline one because the single crystalline NMC721 electrodes have a much higher cathode density and thereby less porosity. Therefore, the improvement is more obvious: the initial capacity is improved from 4.2 Ah to 5.0 Ah.

### Cycling Stability/Battery Lifetime:

The cycling stability is evaluated using a charging/discharging rate of 0.5 C. In batteries, wetting is critical for cycling performance, since the consumption and non-uniform distribution of electrolytes induced during cycling is a major cause for capacity fading. The results show that a significantly improved cycling stability is achieved when the surfactants are used. Detailed results are disclosed below.

### Dendrite Suppression:

Dendrites are usually not easy to form in lithium-ion batteries under normal working conditions, but they are easy to form when working in the conditions of overcharge. To avoid the dendrite formation, the anode/cathode capacity ratio is usually set to ˜1.1. This was typical for the battery testing disclosed herein. To evaluate dendrite suppression effects, the upper cut-off voltage was set as 4.35 V for poly NMC532 batteries, which would contribute nearly 20% extra capacity and encourage dendrite formation.

### Summary of Testing:

For the testing, between 0.1 to 5% by weight of the various oligomers were added to the electrolyte of choice and the battery setup. The battery performance was then evaluated for the ability to overcome the various problems associated with metal ion batteries. The results were compared to blank samples that do not contain the various oligomers.

It was discovered that surfactants as disclosed herein address the following issues: dendrite suppression, battery lifetime, initial capacity, capacity fade, wetting time, and low/high temperature operation.

### Preparation of Surfactants

Some representative examples of the synthesis of the R_{f}-oligomers disclosed herein are provided below.

### Example 1

### Perfluoromercapto-(AA)₄ Oligomer

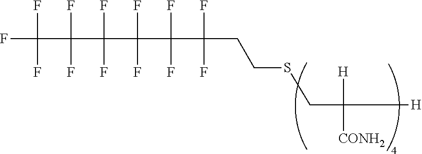

To a 500 mL glass bottle, at room temperature, were charged acrylamide (33.7 g, 0.47 mol), 3,3,4,4,5,5,6,6,7,7,8,8,8-tridecafluorooctane-1-thiol, (45.0 g, 0.12 mol) and 2-propanol (300 mL) as solvent. The mixture was stirred to dissolve the mixture and then the solution was purged with nitrogen for 10 minutes. Vazo-52 (0.6 g, 0.002 mol) was added to the mixture and then the solution was purged with nitrogen for an additional 10 minutes The glass bottle was sealed and transferred to a water bath at 80-85° C. The reaction medium was held at 80-85° C. for 2 hours. The reaction medium was removed from the water bath and transferred to a 1 L crystallizing dish to allow the solvent to evaporate at room temperature in a fume hood for 2 to 3 days and then dried in an oven at 50° C. overnight (17 h) to afford a white powder (49.1 g, 63.2%).

### Example 2

### Perfluoromercapto-(AA)₆ Oligomer

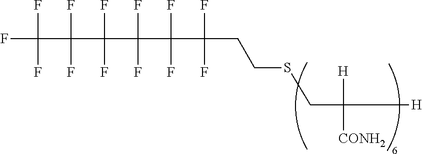

To a 500 mL glass bottle, at room temperature, were charged acrylamide (50.5 g, 0.71 mol), 3,3,4,4,5,5,6,6,7,7,8,8,8-tridecafluorooctane-1-thiol, (1) (45.0 g, 0.12 mol) and 2-propanol (300 mL) as solvent. The mixture was stirred to dissolve the mixture and then the solution was purged with nitrogen for 10 minutes. Vazo-52 (0.6 g, 0.002 mol) was added to the mixture and then the solution was purged with nitrogen for an additional 10 minutes The glass bottle was sealed and transferred to a water bath at 80-85° C. The reaction medium was held at 80-85° C. for 2 hours. The reaction medium was removed from the water bath and transferred to a 1 L crystallizing dish to allow the solvent to evaporate at room temperature in a fume hood for 2 to 3 days and then dried in an oven at 50° C. overnight (17 h) to afford a white powder (71.4 g, 74%).

Using the procedure outlined in Examples 1 and 2, differing only in the stoichiometry of acrylamide the following oligomers were made:

| Example # | Monomer | Oligomerization (n) | Yield (%) |
|---|---|---|---|
| 3 | CH₂CHCONH₂ | 8 | 84.9 |
| 4 | CH₂CHCONH₂ | 9 | 85.3 |
| 5 | CH₂CHCONH₂ | 12 | 86.0 |
| 6 | CH₂CHCONH₂ | 15 | 88.6 |
| 7 | CH₂CHCONH₂ | 20 | 91.5 |
| 8 | CH₂CHCONH₂ | 30 | 93.6 |

### Example 9

To prepare example 9, the procedure outlined in Examples 1 and 2 is used, except: the starting thiol is 3,3,4,4,5,5,6,6,7,7,8,8,9,9,10,10,10-Heptadecafluoro-1-decanethiol, and the stoichiometry between acrylamide and the above thiol is 15 to 1.

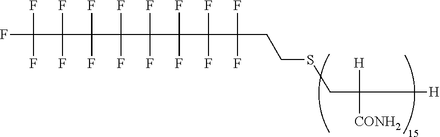

To a 500 mL glass bottle, at room temperature, were charged acrylamide (24.4 g, 0.34 mol), 3,3,4,4,5,5,6,6,7,7,8,8,9,9,10,10,10-Heptadecafluoro-1-decanethiol (11.0 g, 0.02 mol) and 2-propanol (200 mL) as solvent. The mixture was stirred to dissolve the mixture and then the solution was purged with nitrogen for 10 minutes. Vazo-52 (0.3 g, 0.001 mol) was added to the mixture and then the solution was purged with nitrogen for an additional 10 minutes. The glass bottle was sealed and transferred to a water bath at 80-85° C. The reaction medium was held at 80-85° C. for 2 hours. The reaction medium was removed from the water bath and transferred to a 1 L crystallizing dish to allow the solvent to evaporate at room temperature in a fume hood for 2 to 3 days and then dried in an oven at 50° C. overnight (17 h) to afford a white powder (31.6 g, 89.2%).

### Example 10

Dodecane thiol hydrocarbon acrylamide oligomer

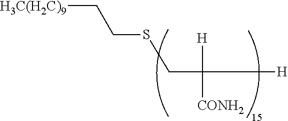

To a 500 mL glass bottle, at room temperature, were charged acrylamide (74.6 g, 1.05 mol), dodecanethiol (14.2 g, 0.07 mol) and 2-propanol (200 mL) as solvent. The mixture was stirred to dissolve the mixture and then the solution was purged with nitrogen for 10 minutes. Vazo-52 (0.6 g, 0.002 mol) was added to the mixture and then the solution was purged with nitrogen for an additional 10 minutes The glass bottle was sealed and transferred to a water bath at 80-85° C. The reaction medium was held at 80-85° C. for 2 hours. The reaction medium was removed from the water bath and transferred to a 1 L crystallizing dish to allow the solvent to evaporate at room temperature in a fume hood for 2 to 3 days and then dried in an oven at 50° C. overnight (17 h) to afford a white powder (76.9 g, 85.4%).

### Example 11

### Preparation of a perfluoromercapto-Acrylamide (AA) Acrylic acid (GAA) Co-Oligomer

Perfluoromercapto-(AA)₄(GAA)₄ Co-Oligomer

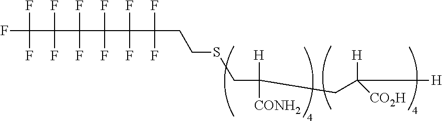

To a 250 mL glass bottle, at room temperature, were charged acrylamide (6.86 g, 0.10 mol), acrylic acid (6.96 g 0.10 mol), 3,3,4,4,5,5,6,6,7,7,8,8,8-tridecafluorooctane-1-thiol, (1) (9.20 g, 0.02 mol) and methanol (200 mL) as solvent. The mixture was stirred to dissolve the mixture and then the solution was purged with nitrogen for 10 minutes. Vazo-52 (0.6 g, 0.002 mol) was added to the mixture and then the solution was purged with nitrogen for an additional 10 minutes The glass bottle was sealed and transferred to a water bath at 70-75° C. The reaction was held at 80-85° C. for 2 hours. The reaction mixture was removed from the water bath and transferred to a 1 L crystallizing dish to allow the solvent to evaporate at room temperature in a fume hood for 2 to 3 days and then dried in an oven at 50° C. overnight (17 h) to afford a white powder (21.5 g, 94%).

### Example 12

### Preparation of a perfluoromercapto-Acrylamide (AA) Acrylic acid (GAA) Co-Oligomer

Perfluoromercapto-(AA)₈(GAA)₁ Co-Oligomer

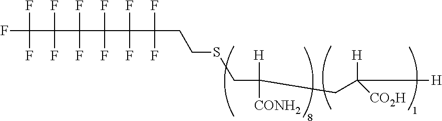

To a 500 mL glass bottle, at room temperature, were charged acrylamide (54.9 g, 0.84 mol), acrylic acid (7.6 g 0.01 mol), 3,3,4,4,5,5,6,6,7,7,8,8,8-tridecafluorooctane-1-thiol, (1) (4.0 g, 0.1 mol) and 2-propanol (250 mL) as solvent. The mixture was stirred to dissolve the mixture and then the solution was purged with nitrogen for 10 minutes. Vazo-52 (0.6 g, 0.002 mol) was added to the mixture and then the solution was purged with nitrogen for an additional 10 minutes The glass bottle was sealed and transferred to a water bath at 80-85° C. The reaction was held at 80-85° C. for 2 hours. The reaction mixture was removed from the water bath and transferred to a 1 L crystallizing dish to allow the solvent to evaporate at room temperature in a fume hood for 2 to 3 days and then dried in an oven at 50° C. overnight (17 h) to afford a white powder (67.2 g, 94%).

### Example 13

### Preparation of a perfluoromercapto-Acrylamide (AA) Acrylic acid (GAA) Co-Oligomer

Perfluoromercapto-(AA)₁₄(GAA)₁ Co-Oligomer

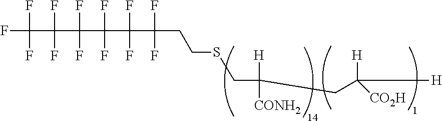

To a 500 mL glass bottle, at room temperature, were charged acrylamide (73.3 g, 1.03 mol), acrylic acid (5.3 g 0.07 mol), 3,3,4,4,5,5,6,6,7,7,8,8,8-tridecafluorooctane-1-thiol, (1) (28 g, 0.07 mol) and 2-propanol (250 mL) as solvent. The mixture was stirred to dissolve the mixture and then the solution was purged with nitrogen for 10 minutes. Vazo-52 (0.6 g, 0.002 mol) was added to the mixture and then the solution was purged with nitrogen for an additional 10 minutes The glass bottle was sealed and transferred to a water bath at 80-85° C. The reaction was held at 80-85° C. for 2 hours. The reaction mixture was removed from the water bath and transferred to a 1 L crystallizing dish to allow the solvent to evaporate at room temperature in a fume hood for 2 to 3 days and then dried in an oven at 50° C. overnight (17 h) to afford a white powder (100.2 g, 94%).

### Example 14

### Preparation of a perfluoromercapto-Acrylamide (AA) Acrylic acid (GAA) Co-Oligomer

Perfluoromercapto-(AA)₄(GAA)₁ Co-Oligomer

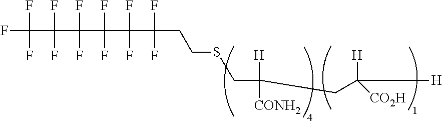

To a 500 mL glass bottle, at room temperature, were charged acrylamide (22.45 g, 0.32 mol), acrylic acid (5.69 g 0.08 mol), 3,3,4,4,5,5,6,6,7,7,8,8,8-tridecafluorooctane-1-thiol, (1) (30 g, 0.08 mol) and 2-propanol (250 mL) as solvent. The mixture was stirred to dissolve the mixture and then the solution was purged with nitrogen for 10 minutes. Vazo-52 (0.4 g, 0.002 mol) was added to the mixture and then the solution was purged with nitrogen for an additional 10 minutes The glass bottle was sealed and transferred to a water bath at 80-85° C. The reaction was held at 80-85° C. for 2 hours. The reaction mixture was removed from the water bath and transferred to a 1 L crystallizing dish to allow the solvent to evaporate at room temperature in a fume hood for 2 to 3 days and then dried in an oven at 50° C. overnight (17 h) to afford a white powder (43.4 g, 73%).

### Example 15

### Preparation perfluoromercapto-Acrylamide (AA) Acrylic acid esters (GAA) Co-Oligomers

Perfluoromercapto-(AA)₄(MA)₁ Co-Oligomer

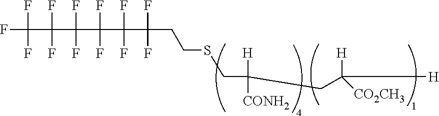

To a 500 mL glass bottle, at room temperature, were charged acrylamide (22.45 g, 0.32 mol), methyl acrylate (6.8 g 0.08 mol, MA), 3,3,4,4,5,5,6,6,7,7,8,8,8-tridecafluorooctane-1-thiol, (1) (30 g, 0.08 mol) and 2-propanol (250 mL) as solvent. The mixture was stirred to dissolve the mixture and then the solution was purged with nitrogen for 10 minutes. Vazo-52 (0.4 g, 0.002 mol) was added to the mixture and then the solution was purged with nitrogen for an additional 10 minutes The glass bottle was sealed and transferred to a water bath at 80-85° C. The reaction was held at 80-85° C. for 2 hours. The reaction mixture was removed from the water bath and transferred to a 1 L crystallizing dish to allow the solvent to evaporate at room temperature in a fume hood for 2 to 3 days and then dried in an oven at 50° C. overnight (17 h) to afford a white powder (49.9 g, 73%).

### Example 16

### Preparation perfluoromercapto-Acrylamide (AA) Acrylic acid esters (GAA) Co-Oligomers

Perfluoromercapto-(AA)₄(BA)₁ Co-Oligomer

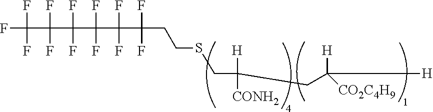

To a 500 mL glass bottle, at room temperature, were charged acrylamide 622.45 g, 0.32 mol), butyl acrylate (10.12 g 0.08 mol, BA), 3,3,4,4,5,5,6,6,7,7,8,8,8-tridecafluorooctane-1-thiol, (1) (30 g, 0.08 mol) and 2-propanol (250 mL) as solvent. The mixture was stirred to dissolve the mixture and then the solution was purged with nitrogen for 10 minutes. Vazo-52 (0.4 g, 0.002 mol) was added to the mixture and then the solution was purged with nitrogen for an additional 10 minutes The glass bottle was sealed and transferred to a water bath at 80-85° C. The reaction was held at 80-85° C. for 2 hours. The reaction mixture was removed from the water bath and transferred to a 1 L crystallizing dish to allow the solvent to evaporate at room temperature in a fume hood for 2 to 3 days and then dried in an oven at 50° C. overnight (17 h) to afford a white powder (43.1 g, 68%).

### Example 17

### Preparation of perfluoromercapto-Acrylamide (AA) perfluoromethacrylate (PFMA) Co-Oligomers

Perfluoromercapto-(AA)₄(PFMA)₁ Co-Oligomer

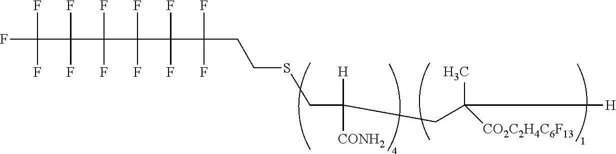

To a 500 mL glass bottle, at room temperature, were charged acrylamide (8.23 g, 0.12 mol), 3,3,4,4,5,5,6,6,7,7,8,8,8-tridecafluorooctyl-2-methacrylate (12.5 g 0.03 mol, PFMA), 3,3,4,4,5,5,6,6,7,7,8,8,8-tridecafluorooctane-1-thiol, (1) (11 g, 0.03 mol) and 2-propanol (200 mL) as solvent. The mixture was stirred to dissolve the mixture and then the solution was purged with nitrogen for 10 minutes. Vazo-52 (0.4 g, 0.002 mol) was added to the mixture and then the solution was purged with nitrogen for an additional 10 minutes The glass bottle was sealed and transferred to a water bath at 80-85° C. The reaction was held at 80-85° C. for 2 hours. The reaction mixture was removed from the water bath and transferred to a 1 L crystallizing dish to allow the solvent to evaporate at room temperature in a fume hood for 2 to 3 days and then dried in an oven at 50° C. overnight (17 h) to afford a white powder (22.2 g, 70%).

### Example 18

### Preparation of perfluoromercapto-Acrylamide (AA) perfluoromethacrylate (PFMA) Co-Oligomers

Perfluoromercapto-(AA)₁₄(PFMA)₁ Co-Oligomer

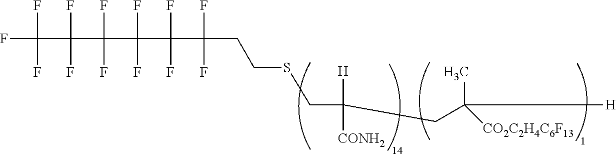

To a 500 mL glass bottle, at room temperature, were charged acrylamide (28.81 g, 0.12 mol), 3,3,4,4,5,5,6,6,7,7,8,8,8-tridecafluorooctyl-2-methacrylate (12.5 g 0.03 mol, PFMA), 3,3,4,4,5,5,6,6,7,7,8,8,8-tridecafluorooctane-1-thiol, (1) (11.0 g, 0.03 mol) and 2-propanol (200 mL) as solvent. The mixture was stirred to dissolve the mixture and then the solution was purged with nitrogen for 10 minutes. Vazo-52 (0.4 g, 0.002 mol) was added to the mixture and then the solution was purged with nitrogen for an additional 10 minutes The glass bottle was sealed and transferred to a water bath at 80-85° C. The reaction was held at 80-85° C. for 2 hours. The reaction mixture was removed from the water bath and transferred to a 1 L crystallizing dish to allow the solvent to evaporate at room temperature in a fume hood for 2 to 3 days and then dried in an oven at 50° C. overnight (17 h) to afford a white powder (42.7 g, 82%).

### Example 19

### Preparation of perfluoromercapto-poly-N-vinyl-2-pyrollidinone (PV2P) oligomers

### Perfluoromercapto-(PV2P)₄ Oligomer

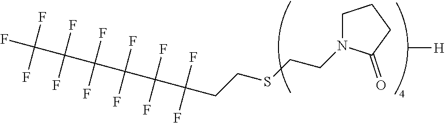

To a 500 mL glass bottle, at room temperature, were charged n-Vinyl-2-pyrollidinone (58.5 g, 0.53 mol), 3,3,4,4,5,5,6,6,7,7,8,8,8-tridecafluorooctane-1-thiol, (1) (50 g, 0.13 mol) and 2-propanol (300 mL) as solvent. The mixture was stirred to dissolve the mixture and then the solution was purged with nitrogen for 10 minutes. Vazo-52 (0.4 g, 0.002 mol) was added to the mixture and then the solution was purged with nitrogen for an additional 10 minutes The glass bottle was sealed and transferred to a water bath at 80-85° C. The reaction was held at 80-85° C. for 2 hours. The reaction mixture was removed from the water bath and transferred to a 1 L crystallizing dish to allow the solvent to evaporate at room temperature in a fume hood for 2 to 3 days and then dried in an oven at 50° C. overnight (17 h) to afford a white powder (101.8 g, 94%).

Using these conditions, the following series of N-vinyl-2-pyrollidinoine oligomers were prepared

| | | Oligomerization | Amount | Yield |
|---|---|---|---|---|
| Example # | Monomer | (n) | (g) | (%) |
| 20 | N-vinyl2-pyrolldinone | 8 | 61.4 | 92.0 |
| 21 | N-vinyl2-pyrolldinone | 14 | 102 | 99.9 |
| 22 | N-vinyl2-pyrolldinone | 30 | 68.2 | 87.2 |
| 23 | N-vinyl2-pyrolldinone | 40 | 67.5 | 88.6 |

### Example 24

### Preparation of perfluoromercapto-poly 1-Propanesulfonic acid, 2-methyl-2-[(1-oxo-2-propen-1-yl)amino]-, sodium salt (AMPS) oligomers

### Perfluoromercapto-(AMPS)₄ Oligomer

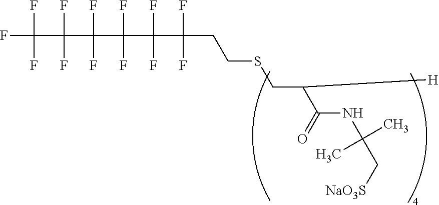

To a 500 mL glass bottle, at room temperature, were charged 50% aqueous sodium 2-methyl-2-[(1-oxo-2-propen-1-yl)amino]-1-propanesulfonate (154 g, 0.34 mol), 3,3,4,4,5,5,6,6,7,7,8,8,8-tridecafluorooctane-1-thiol, (1) (32 g, 0.08 mol) and 2-propanol (300 mL) as solvent. The mixture was stirred giving 2 phases. Then reaction mixture was purged with nitrogen for 10 minutes. Vazo-52 (0.4 g, 0.002 mol) was added to the mixture and then the solution was purged with nitrogen for an additional 10 minutes The glass bottle was sealed and transferred to a water bath at 80-85° C. The reaction was held at 80-85° C. for 2 hours. A portion of reaction mixture was removed from the water bath and transferred to a 1 L crystallizing dish to allow the solvents to evaporate at room temperature in a fume hood for 5 to 6 days and then dried in an oven at 50° C. overnight (48 h) to afford a white powder (17.5 g, 17.4%).

### Example 25

### Preparation of perfluoromercapto-poly 1-Propanesulfonic acid, 2-methyl-2-[(1-oxo-2-propen-1-yl)amino]-, sodium salt (AMPS) oligomers

### Perfluoromercapto-(AMPS)₁₄ Oligomer

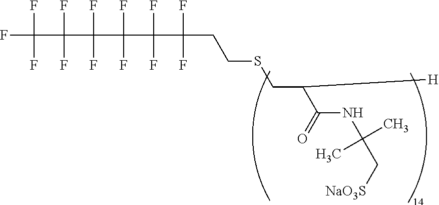

To a 500 mL glass bottle, at room temperature, were charged 50% aqueous sodium 2-methyl-2-[(1-oxo-2-propen-1-yl)amino]-1-propanesulfonate (154 g, 0.34 mol), 3,3,4,4,5,5,6,6,7,7,8,8,8-tridecafluorooctane-1-thiol, (1) (32 g, 0.08 mol) and 2-propanol (300 mL) as solvent. The mixture was stirred giving 2 phases. Then reaction mixture was purged with nitrogen for 10 minutes. Vazo-52 (0.4 g, 0.002 mol) was added to the mixture and then the solution was purged with nitrogen for an additional 10 minutes The glass bottle was sealed and transferred to a water bath at 80-85° C. The reaction was held at 80-85° C. for 2 hours. A portion of reaction mixture was removed from the water bath and transferred to a 1 L crystallizing dish to allow the solvents to evaporate at room temperature in a fume hood for 5 to 6 days and then dried in an oven at 50° C. overnight (48 h) to afford a white powder (27.1 g, 10%).

### Batteries Tested

Two types of cathodes were used for the batteries evaluation: either polycrystalline LiNi_{0.5}Mn_{0.3}Co_{0.2}O₂(NMC 532) or single crystalline LiNi_{0.5}Mn_{0.3}Co_{0.2}O₂(NMC 721). The anode was unchanged (Name and type of anode: Lithium intercalated graphite) same as the general electrolyte (LD50 from Gotion).

List of all the classes/family of R_{f}-oligomers disclosed herein that have been tested:
Polyethylene oxide
Lithium salt of a R_{f}-oligomer
Amphoteric/Zwiterionic
Acrylamide oligomers
Acrylamide co-oligomers
N Vinyl Pyrrolidone oligomers
Phosphate
Sulfonate
Cationic
Blends anionic, cationic, non-ionic

### List of the Four Evaluated Performance Parameters:

Wetting time
Initial capacity
Capacity retention
Dendrite suppression

### Wetting Time in LIBs

Electrochemical Impedance Spectroscopy (EIS) was used to test the internal resistance change of batteries. After the injection of the electrolyte, the internal resistance would change with the permeation of the electrolyte. The resistance would achieve a balance when the electrode is fully wetted.

As shown in FIG. 1, the effect of several electrolyte formulations were tested for the ability to decrease wetting time. LP50 electrolyte alone (black squares) was used as a control and was compared to LP50 combined with each of Dupont Zonyl FSA (red circles), 3M FC-4430 (blue triangles), the compound according to Example 2 (1%), and the compound according to Example 6 (1%). The data shows that the curvature radius of the LP50 control is much greater than when mixed with the compound according to either Examples 2 or 6. This is apparent in the shape of the curves from 0 min to ˜240 min post injection. As can be seen, when the electrolyte included the compounds of Examples 2 or 6, the electrolyte resistance plateaued substantially more quickly, resulting in the observed decrease in curvature radius. Furthermore, the observed curvature radius of Examples 2 and 6 (comprising acrylamide oligomers) were also substantially smaller than electrolyte comprising the DuPont Zonyl FSA and 3M FC-4430 (non-acrylamide). Specifically, the observed electrolyte resistance plateaued at around 2 hours post-injection for Examples 2 and 6, while the observed electrolyte resistance plateaued at about 4 hours for 3M FC-4430.

### Initial Capacity

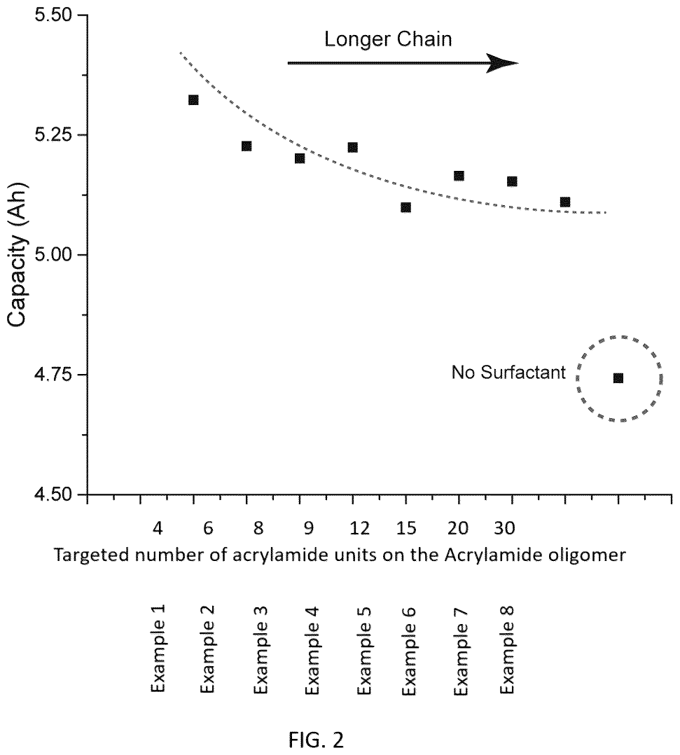

As shown in FIG. 2, different R_{f}-oligomers were tested having the same functional groups but different skeletal lengths comprising acrylamide units in a battery comprising nickel, manganese, cobalt polycrystalline cathodes (NMC 532 cells). All the surfactants show a significantly improved initial capacity (˜5.2 Ah), showing that better wetting brought by the surfactants makes more electrode materials active. For comparison, the batteries without R_{f}-oligomers have capacities of ˜4.75 Ah (FIG. 2). The surfactants exhibit a “smile” curve showing that the molecules with shorter skeletal length and longer skeletal length have better performance (FIG. 2). Table 1, below, correlates the R_{f}-oligomers referenced on the graph of FIG. 2 to the corresponding targeted number of acrylamide units per molecule.

TABLE 1

| Targeted number of Acrylamide | |
|---|---|
| unit per molecule | Fluorosurfactant reference on the graph |
| 4 | Example 1 |
| 6 | Example 2 |
| 8 | Example 3 |
| 9 | Example 4 |
| 12 | Example 5 |
| 15 | Example 6 |
| 20 | Example 7 |
| 30 | Example 8 |

### Cycling Stability/Battery Lifetime

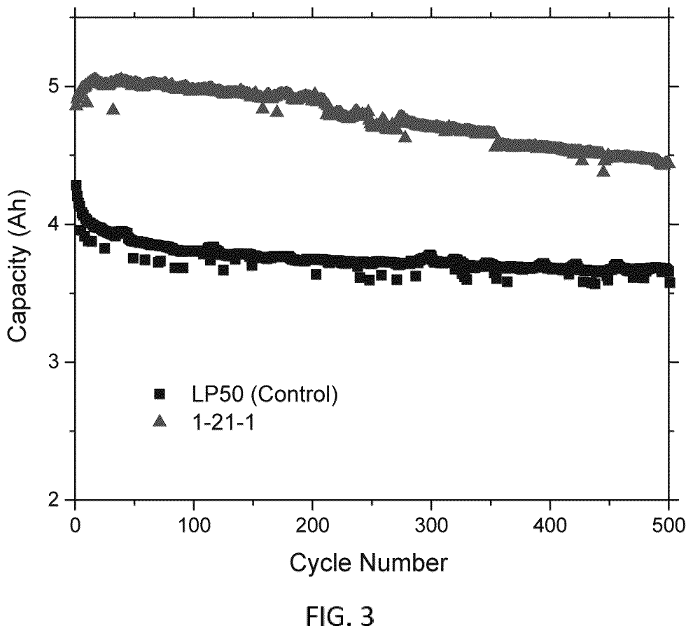

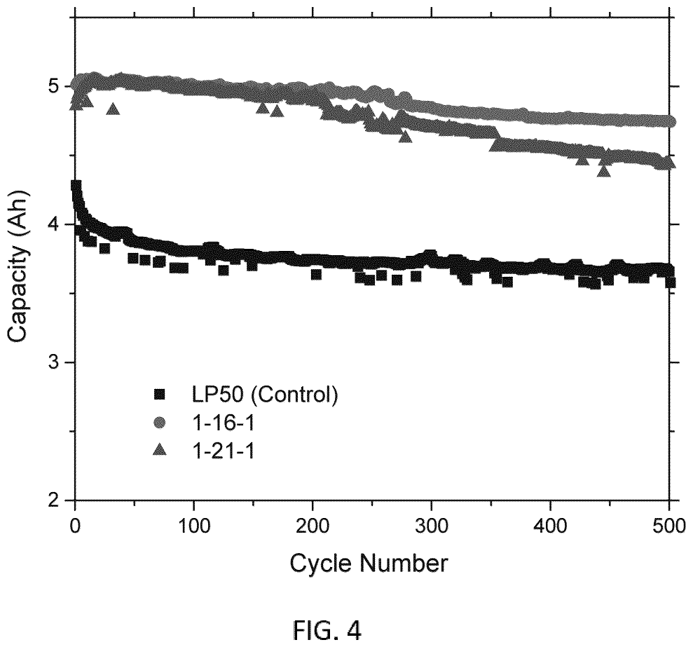

As shown in FIGS. 3 and 4, the electrolyte LP50 alone or combined with the compound of Examples 1 or 6 were tested for cycling stability over 500 cycles. After 500 cycles, the R_{f}-oligomers according to Examples 1 and 6 were able to significantly improve maintenance of battery capacity. As shown in FIG. 4, the battery having LP50 electrolyte alone showed a drop in capacity from 4.32 Ah to 3.66 Ah over 500 cycles, which amounts to 85% capacity conserved. By contrast, the battery having electrolyte with R_{f}-oligomers of Example 1 showed a drop in capacity from 5 Ah to 4.75 Ah, which amounts to 95% capacity conserved. Similarly, the battery having electrolyte with R_{f}-oligomers of Example 6 showed a drop in capacity from 4.86 Ah to 4.44 Ah, which amounts to 91% capacity conserved. Thus, the R_{f}-oligomers disclosed herein were effective to maintain 95 to 91% of initial battery capacity when the control can only maintain 85% of its initial capacity. It is also noted that the initial battery's capacity is increased when R_{f}-oligomers of Examples 1 and 6. The data of FIGS. 3 and 4 is summarized in Table 2, below.

TABLE 2

| | | | | % Capacity |
|---|---|---|---|---|
| | Number of | Initial | | conserved |
| | acrylamide | capacity | Capacity after | after 500 |
| | units | (Ah) | 500 cycles (Ah) | cycles |
| Control LP50 | NA | 4.32 | 3.66 | 85% |
| Example 1 | 4 | 5 | 4.75 | 95% |
| Example 6 | 15 | 4.86 | 4.44 | 91% |

Additional Examples were tested for capacity retention relative to LP50 control according to the protocol above, the results of which are summarized below:

| Example # | Capacity Retention | Solubility in Electrolyte |
|---|---|---|
| Example 14 | Average | Soluble |
| Example 15 | Average | Soluble |
| Example 16 | Average | Soluble |
| Example 17 | Average | Soluble |
| Example 18 | Average | Soluble |
| Example 20 | Good (but less than Example 1) | Poor solubility |
| Example 22 | Good (but less than Example 1) | Poor solubility |
| Example 23 | Good (but less than Example 1) | Poor solubility |

The examples having “average” capacity retention had similar capacity retention compared to electrolyte alone after 500 cycles. The Examples having “good” capacity retention had higher capacity retention compared to electrolyte alone after 500 cycles but were not as beneficial as Example 1.

### Dendrite Suppression

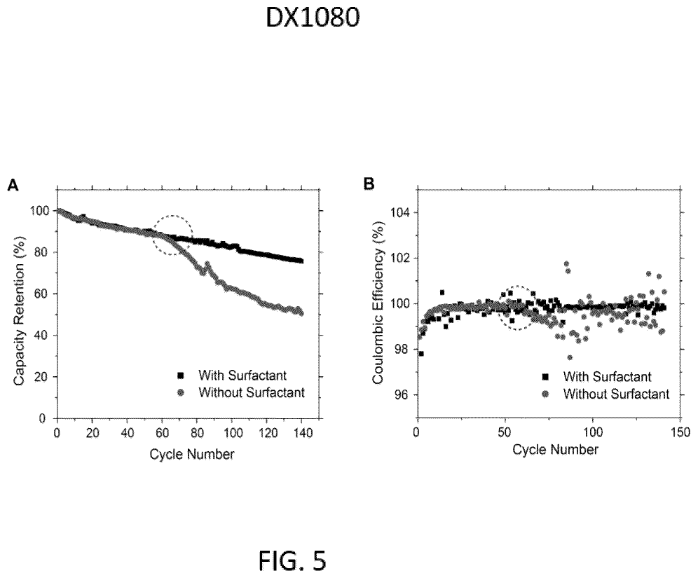

As shown in FIG. 5, dendrite suppression performance was evaluated based on electrochemical data and SEM pictures. This evaluation was performed by using dried DX1080 that consists of R_{f}-oligomers. DX1080 was dried by heating in a vacuum oven to dry until constant weight was achieved.

### Battery Cycling Performance

The NMC 532 polycrystalline batteries were tested with a high cut-off voltage of 4.35 V and a rate of 0.5 C. For the control group, the battery shows a typical dendrite formation behavior, and the capacity plunge after ˜70 cycles (FIG. 5A). Such a drastic capacity fade can be attributed to the formation of dendrite growth, which usually results in dead lithium and a large amount of lithium-ion loss. Correspondingly, it was observed that the Coulombic Efficiency (defined as the ratio of output of charge of a battery to input of charge) start to fluctuate near 70 cycles, and is lower than 100% (FIG. 5B). This evidence shows the formation of lithium dendrite on graphite anode during cycling under overcharge conditions.

Comparatively, the battery with surfactants shows steady cycling. The capacity retention is 86.4% and 75.6% after 67 cycles and 140 cycles, respectively, significantly higher than 84.1% and 50.46% of the control group (Table 3).

TABLE 3
The comparison of battery cycling with and without surfactant.

| | Capacity Retention | Capacity Retention |
|---|---|---|
| | (67th cycles) | (140th cycles) |
| With surfactant | 86.4 | 75.6 |
| Without surfactant | 84.1 | 50.46 |

More importantly, the Coulombic efficiency is also steady around 100%, showing no dead lithium formation under such a high cut-off voltage. This result shows that the surfactant can effectively protect the formation of lithium dendrite under the overcharge condition.

### Characterization of Graphite Anode

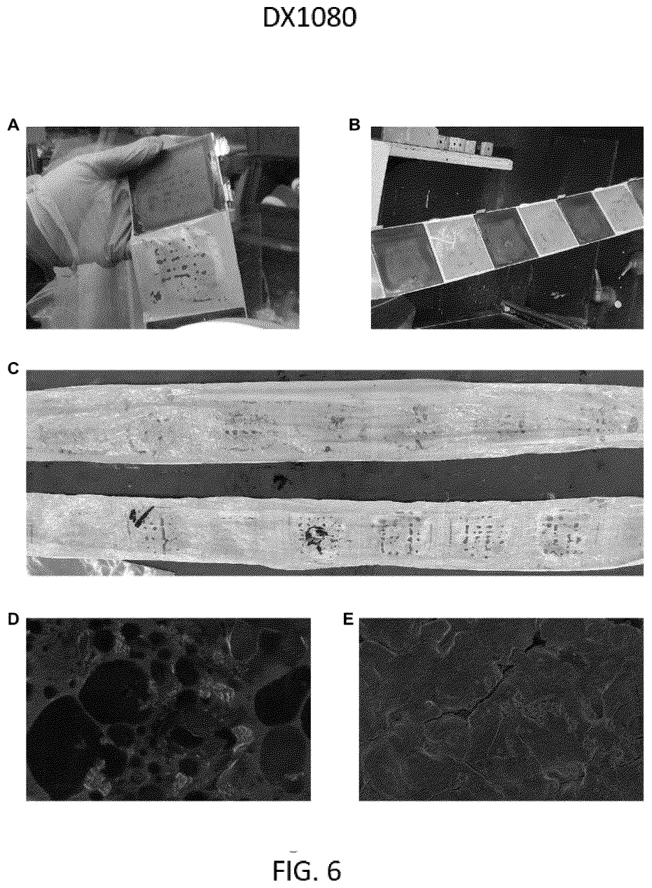

To further confirm that the surfactant can suppress the dendrite growth, the graphite anode was characterized after cycling. As shown in FIG. 6A, a large amount of dead lithium can be found deposited onto the separator and graphite when no surfactant is used. The dead lithium is also very flammable and can spontaneous-combust when exposed to air, showing that the dotted like dead lithium should be responsible for the capacity fade. On the contrary, the graphite electrodes and separators are much cleaner when the surfactant is used, showing that the dead lithium/lithium dendrite is alleviated under the overcharge condition FIG. 6B-C. These results are further verified by SEM pictures, where the electrodes with surfactant exhibit a much more flat surface (FIG. 6E) than the one without surfactant (FIG. 6D).

These electrochemical results and characterization show that the R_{f}-oligomers present in DX1080 can effectively suppress the dendrite growth.

All documents cited in this application are hereby incorporated by reference as if recited in full herein.

Although illustrative embodiments of the present disclosure have been described herein, it should be understood that the disclosure is not limited to those described, and that various other changes or modification may be made by one of ordinary skill in the art without departing from the scope or spirit of the invention.

What is claimed is:

1. An ion battery electrolyte comprising:
an electrolyte salt;
a solvent; and
at least one fluorocarbon surfactant according to Formula I: 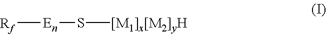
wherein R_{f} is a straight or branched chain perfluoroalkyl of 4 to 18 carbon atoms, perfluoroalkyloxyalkylene of 5 to 19 carbon atoms, or mixtures thereof, Eₙ is a straight or branched chain alkylene of 1 to 12 carbon atoms, —CON(R′)-E′-, —SO₂N(R′)-E′-, -E″-CON(R′)-E′-, -E″-S-E′-, -E″-N(R′)-E′-; or -E″-SO₂N(R′)-E′-, where R′ is hydrogen or alkyl of 1 to 6 carbon atoms, E′ is alkylene of 2 to 8 carbon atoms and E″ is alkylene of 1 to 4 carbon atoms;
[M₁] represents a hydrophilic monomer unit derived from a hydrophilic monomer of the type M₁; and
[M₂] represents a hydrophobic monomer unit derived from hydrophobic monomers of the type M₂;
wherein M₁ is optionally more than one type of monomer and M₂ is optionally more than one type of monomer;
wherein the sum of x and y is between 1 and about 500; x/(x+y) is between 1 and 0.5; and n is 0 or 1

2. The ion battery electrolyte of claim 1, wherein the at least one fluorocarbon surfactant according to Formula I comprises about 0.1% to about 5% by weight of the electrolyte.

3. The ion battery electrolyte of claim 1, wherein M₁ is an acrylamide unit.

4. The ion battery electrolyte of claim 1, wherein the electrolyte salt is an electrolyte lithium salt.

5. The ion battery electrolyte of claim 4, wherein the electrolyte lithium salt is selected from LiClO₄, LiPF₆, LiBF₄, LiCF₃SO₃, LiN(CF₃SO₂)₂, or combinations thereof.

6. The ion battery electrolyte of claim 1, wherein the solvent comprises one or more of dimethyl carbonate, diethyl carbonate, methyl ethyl carbonate.

7. The ion battery electrolyte of claim 1, wherein the electrolyte comprises one or more of compounds according to Example 1, Example 2, Example 3, Example 4, Example 5, Example 6, Example 7, Example 8, Example 9, Example 10, Example 11, Example 12, Example 13, Example 14, Example 15, Example 16, Example 17, Example 18, Example 19, Example 20, Example 21, Example 22, Example 23, Example 24, and Example 25.

8. The ion battery electrolyte of claim 1, wherein the electrolyte comprises one or more of DX1080 and DX1090.

9. An ion battery comprising:
a housing comprising an electric core; and
an electrolyte disposed in said housing, wherein the electric core is in contact with the electrolyte;
wherein the electrolyte is the ion battery electrolyte of claim 1.

10. The ion battery of claim 9, wherein the ion battery is a lithium ion battery.

11. The ion battery of claim 10, wherein the lithium salt is selected from LiClO₄, LiPF₆, LiBF₄, LiCF₃SO₃, LiN(CF₃SO₂)₂, or combinations thereof.

12. The ion battery of claim 9, wherein the electrolyte comprises a solvent selected from dimethyl carbonate, diethyl carbonate, methyl ethyl carbonate, and combinations thereof.

13. A method for improving performance of a metal ion battery comprising the step of contacting the metal ion battery with the ion battery electrolyte of claim 1.

14. The method of claim 13, wherein the improved performance includes improved charge capacity, fade during charge, and discharge cycling of the metal ion battery.

15. The method of claim 13, wherein the improved performance includes reduced dendrite formation during charge and discharge cycling of the metal ion battery.

16. The method of claim 13, wherein the improved performance includes an increased lifetime of the metal ion battery.

17. The method of claim 13, wherein the metal ion battery is a lithium ion battery.

18. A method of decreasing the time required to wet the electrode of a metal ion battery, comprising the step of contacting the electrode with the ion battery electrolyte of claim 1.

19. The method of claim 18, wherein the metal ion battery is a lithium ion battery.

20. The method of claim 18, wherein the electrolyte salt is selected from LiClO₄, LiPF₆, LiBF₄, LiCF₃SO₃, LiN(CF₃SO₂)₂, or combinations thereof.

21. The method of claim 18, wherein the solvent comprises one or more of dimethyl carbonate, diethyl carbonate, methyl ethyl carbonate, and combinations thereof.

22. The ion battery electrolyte of claim 1, wherein the at least one fluorocarbon surfactant comprises: 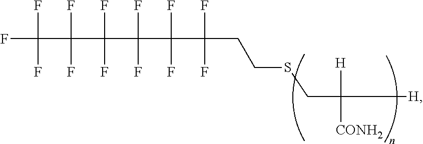
wherein n is an integer from 1 to 30.

23. The ion battery electrolyte of claim 1, wherein the at least one fluorocarbon surfactant comprises:

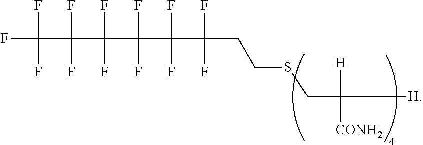

24. The ion battery electrolyte of claim 1, wherein the at least one fluorocarbon surfactant comprises: [chemical structure]
